(19) United States
(12) Patent Application Publication
(10) Pub. No.: US 2022/0036183 A1
(43) Pub. Date: Feb. 3, 2022

(54) METHOD AND DEVICE FOR THE FUSION OF SENSOR SIGNALS USING A NEURAL NETWORK

(71) Applicant: Robert Bosch GmbH, Stuttgart (DE)

(72) Inventors: Simon Weissenmayer, Flein (DE); Wolfgang Boettcher, Richterswil (CH)

(21) Appl. No.: 17/375,556

(22) Filed: Jul. 14, 2021

(30) Foreign Application Priority Data
Jul. 31, 2020 (DE) 102020209684.8

(51) Int. Cl. G06N 3/08; G06N 3/04; G06N 3/063

(52) U.S. Cl. CPC G06N 3/08; G06N 3/063; G06N 3/0472

(57) ABSTRACT

A computer-implemented method for the fusion of a plurality of sensor signals using a neural network, a sensor signal including at least one first value that characterizes an expected value of a physical variable and including a second value that characterizes a scatter of the physical variable. In addition the neural network ascertains, based on the plurality of sensor signals, an output that characterizes a fusion of the plurality of sensor signals. The output is a function of a first intermediate output of the neural network. The first intermediate output is ascertained by at least one first neuron and including an ascertained first value that characterizes an expected value of a fusion of the plurality of sensor values, and including an ascertained second value that characterizes a scatter of the fusion, the ascertained second value of the first intermediate output being set to zero if a specifiable condition is fulfilled.

### CROSS REFERENCE

The present application claims the benefit under 35 U.S.C. § 119 of German Patent Application No. DE 102020209684.8 filed on Jul. 31, 2020, which is expressly incorporated herein by reference in its entirety.

### FIELD

The present invention relates to a method for the fusion of sensor signals, a hardware implementation of the method, a method for training, a training device, a computer program, and a storage medium.

### BACKGROUND INFORMATION

German Patent Application No. DE 10 2020 201 133.8 describes a neural network including stochastic neurons for the fusion of sensor signals.

### SUMMARY

Signals recorded by sensors are typically subject to uncertainty that can be caused for example by environmental or operating conditions of the sensor, or manufacturing tolerances in the production of the sensor. In order to determine a reliable sensor signal, frequently a plurality of sensors of the same type are used, and the correspondingly ascertained sensor signals are fused.

For the fusion of sensor signals, in particular neural networks having stochastic neurons have turned out to be very suitable. These neural networks are capable of fusing sensor signals that have uncertainty.

The calculation of the tasks of a neural network having stochastic neurons can place high demands on the energy requirement of a device used to ascertain the output. In particular in the case of use in mobile terminal devices, or in robots, such as an at least partly automated vehicle, it is therefore desirable to keep the energy requirement of a neural network having stochastic neurons as low as possible. On the other hand, a high level of performance of the sensor signal fusion is desirable. The performance of the sensor signal fusion can, in the context of the present invention, be understood as the ability to achieve a desired result based on the plurality of sensor signals. Here, the performance can be understood as a continuous measure that indicates to what extent the output deviates from the desired result.

### SUMMARY

An advantage of a method in accordance with an example embodiment of the present invention is that the number of required computing operations of a neural network having stochastic neurons can be greatly reduced. In this way, the energy and the need for memory space required by the device for calculating the output of the neural network can be reduced. As a result, given the same energy or memory requirement, the performance of the neural network is improved.

In a first aspect, the present invention relates to a computer-implemented method for fusing a multiplicity of sensor signals using a neural network, a sensor signal including at least one first value that characterizes an expected value of a physical variable and including a second value that characterizes a scatter of the physical variable, and in addition the neural network ascertaining an output, based on the plurality of sensor signals, that characterizes a fusion of the plurality of sensor signals, the output being a function of a first intermediate output of the neural network, the first intermediate output being ascertained by at least one first neuron and including an ascertained first value that characterizes an expected value of a fusion of the plurality of sensor values and including an ascertained second value that characterizes a scatter of the fusion, the ascertained second value of the first intermediate output being set to zero if a specifiable condition is fulfilled.

In the sense of the present invention, a fusion of sensor signals can be understood as a method that combines signals of a plurality of sensors to form a sensor signal, the sensors being configured to measure the same physical variable, and the combined sensor signal characterizing an improved measurement of the physical variable.

In the sense of the present invention, it is possible that the first value be an expected value of the physical variable. The second value can for example be a variance of the measured physical variable. For numerical stability, and for a faster calculation by the neural network, the second value can also, advantageously and preferably, be the reciprocal of the variance. The reciprocal of the variance is in this case also known as the preciseness value. In the sense of the present invention, therefore, a sensor signal can be understood as a measurement of the physical variable that has a degree of uncertainty.

For the measurement of the physical variable, it is possible that the sensor measures a provisional value, and based on this then ascertains a sensor signal that includes a first and a second value. For example, an ultrasonic sensor can measure a runtime and further characteristics of an ultrasonic signal as a provisional value. Based on this provisional value, the ultrasonic sensor can then ascertain a first value and a second value of a desired physical quantity, for example layer thicknesses of a workpiece or wetness values of a roadway surface. A further example is a camera sensor that first measures an image as a provisional value. Based on this image and an image classifier, the camera sensor can then for example ascertain a first value and a second value of a position of an object in the image, the position representing the physical variable.

The first neuron can advantageously be a stochastic neuron. These neurons have turned out to be particularly well-suited for the fusion of sensor signals having uncertainty.

Stochastic neurons are configured to receive at least one first value and a second value of the input or of an intermediate result, and on this basis to in turn ascertain a first value and a second value. Preferably, the first values are each expected values and the second values are each preciseness values. A stochastic neuron can first ascertain a weighting of the received preciseness values according to the equation:

eᵢ=w_{e,i}·e_{o,i}

where e_{o,i} is a value at position i of the received preciseness values, and w_{e,i} is a weight for the value. In addition, a weighting of the received expected values can be carried out according to the equation

μᵢ=w_{μ,i}·μ_{o,i}

where μ_{o,i} is a value at position i of the received expected values and w_{μ,i} is a weight for the value.

On the basis of the weighting of the received preciseness values and the weighting of the received expected values, the stochastic neuron can ascertain the preciseness value according to the equation

$$e = {\sum }_{i} {e}_{i}$$

and can ascertain the expected value according to the equation

$$μ = \frac{1}{e} {\sum }_{i} {μ}_{i} \cdot {e}_{i}$$

The ascertained expected value and the ascertained preciseness value can be forwarded, as at least part of an intermediate result, to another stochastic neuron of the neural network, or can be used as at least part of the output. Consequently, an intermediate result or the output can be made up of at least one expected value and at least one preciseness value.

The method carried out by a stochastic neuron can therefore be understood as a fusion of the plurality of sensor signals, the weights of the stochastic neuron determining how the sensor signals are fused. A plurality of stochastic neurons can be situated in a layer of the neural network. In this case, an intermediate output of the neural network can be understood as a multiplicity of different possible results of a fusion of the sensor signals. The intermediate output can then be forwarded to other layers of the neural network, in order in this way to combine the results of the different fusions with one another. In this way, different fusion strategies can be mapped. The layers of the neural network can in addition include nonlinear activation functions that enable a nonlinear weighting of the plurality of sensor signals in order to ascertain the output. The nonlinear weighting is determined here by the weights of the respective layers. For the training of the weights, machine learning methods can be used, in particular a stochastic gradient descent method. In this way, the method can learn, from data, a fusion strategy that best fits the data. This increases the performance of the fusion method.

It is possible that the ascertained second value of the first intermediate result be set to zero if it falls below a predefined threshold value. Alternatively, it is also possible that the first preciseness value be set to zero if it is smaller than or equal to the first threshold value.

The setting of small second values in the neural network to zero has the advantage that a multiplicity of computing operations that are required in order to ascertain the output contain a multiplication by zero, and thus can be calculated significantly faster. Typically, the operations of the neural network include matrix multiplications and/or matrix additions. The method therefore results in matrix multiplications and/or matrix additions with sparsely occupied matrices. In particular with hardware that is specialized for operations of sparsely occupied matrices, in this way a significant reduction of the computing operations required by the neural network can be achieved. As a result, the energy required to calculate the output is decreased. In addition, the memory use that the calculation of the output requires is reduced. Conversely, given the same energy requirement or the same memory requirement, the performance of the neural network can be improved.

From these two advantages there follows a third advantage. Through the reduction of required energy and computing power, the method can be used in particular in battery-operated devices such as cell phones or robots in order to reduce the energy consumption of the device at the same performance level. This has the result of making possible for the first time the use of the neural network in some devices in which the energy consumption or the required memory space would otherwise be too high.

In a further specific embodiment of the method in accordance with the present invention, it is possible for the first intermediate output to be ascertained by a plurality of neurons, and to include a plurality of ascertained first values and a plurality of ascertained second values, an ascertained second value being set to zero if it belongs to a predefined number of smallest values of the ascertained second values.

For this purpose, the second values can first be sorted by size. Subsequently, the smallest of the second values can be set to zero, namely as many of these smallest values as are specified by the predefined number.

An advantage of this specific embodiment is that the number of second values set to zero can be determined within a layer of the neural network. This brings it about that the reduction of computing operations can be precisely defined. This is advantageous in particular when a computing unit for calculating the first intermediate output is used for which a predefined number of elements of the operation set to zero is advantageous, or that uses the assumption the predefined number of elements is set to zero.

In a further specific embodiment of the present invention, it is possible that the step of ascertaining the first intermediate output is carried out by a computing unit for operations on sparsely occupied matrices, or sparse matrix operations, the computing unit being configured to carry out the operations using a hardware acceleration.

The advantage of this specific embodiment is that the efficiency of the ascertaining of the first intermediate result is further improved.

In addition, the present invention relates to a computer-implemented method for training the neural network, the neural network being trained based on a loss function.

For the training of the neural network, machine learning methods can be used, in particular those that ascertain the weights of the neural network via a form of gradient descent, for example stochastic gradient descent (SGD) or Adam. The weights of the neural network can be understood as the weights that are included in the layers of the neural network.

For the training, preferably training data of sensor signals are used, each training datum including a plurality of sensor signals that are to be fused. For the training, an output of the neural network can then be ascertained for at least one training datum. The ascertained output can then be supplied, together with a desired output for the training datum, to the loss function, which ascertains a difference between the ascertained output and the desired output. As a function of the difference, the weights can then be adapted in order to improve the performance of the neural network.

In a further specific embodiment of the present invention, it is possible that the loss function include a norm of at least a portion of a plurality of weights of the stochastic neuron.

For example, it is possible that the loss function include an L1 norm of at least a portion of the weights of the neural network and/or an L2 norm of at least a portion of the weights of the neural network.

The advantage of the use of a norm of at least a portion of the weights is that the training method provides an incentive that, after the training, a plurality of weights of the neural network is close to zero or equal to zero. The weights are therefore set during the training in such a way that during the operation of the neural network as many computing operations as possible contain a multiplication and/or addition with zero. This further reduces the energy consumption and the memory usage of the required computing operations, and in turn results in an increase in performance.

Below, specific embodiments of the present invention are explained in more detail with reference to the figures.

### BRIEF DESCRIPTION OF THE DRAWINGS

FIG. 1 schematically shows the design of a neural network in accordance with an example embodiment of the present invention.

FIG. 2 schematically shows a design of a control system for controlling an actuator, in accordance with an example embodiment of the present invention.

FIG. 3 schematically shows an exemplary embodiment for the controlling of an at least partly autonomous robots, in accordance with an example embodiment of the present invention.

FIG. 4 schematically shows a training system for training the neural network, in accordance with an example embodiment of the present invention.

### DETAILED DESCRIPTION OF EXAMPLE EMBODIMENTS

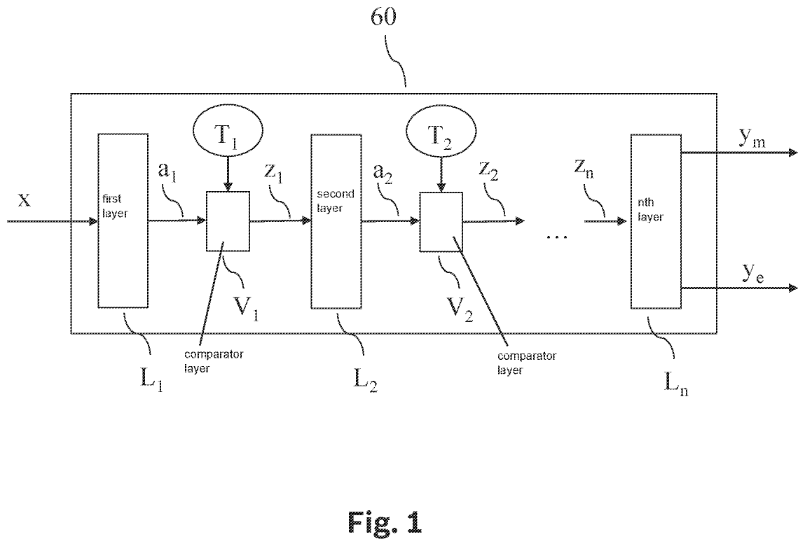

FIG. 1 shows a neural network (60) for the fusion of a plurality (x) of input signals. The neural network (60) includes for this purpose layers (L₁, L₂, Lₙ), the layers each including stochastic neurons. The respective stochastic neurons each ascertain an expected value and a preciseness value. Except for a final layer (Lₙ) of the neural network, the expected values and preciseness values ascertained by the stochastic neurons of a layer (L₁, L₂) are combined in a respective layer output (a₁, a₂) of the respective layer (L₁, L₂).

In a first layer (L₁), the neural network (60) receives the plurality (x) of input signals, and, using the stochastic neurons of the first layer (L₁), ascertains a first layer output (a₁). The first layer output is supplied to a first comparator unit (V₁). The first comparator unit (V₁) ascertains a plurality of preciseness values of the first layer output (a₁) that are smaller than a first threshold value (T₁). The ascertained preciseness values are then set to zero, and the first layer output (a₁), modified in this way, is provided, as first intermediate output (z₁), to a second layer (L₂). In alternative exemplary embodiments (not shown), it is possible that the first comparator unit (V₁) also ascertains, for each preciseness value, whether the preciseness value is below a threshold value defined specifically for the preciseness value.

The second layer receives the first intermediate output (z₁) and, using the stochastic neurons of the second layer (L₂), ascertains a second layer output (a₂). The second layer output is supplied to a second comparator unit (V₂). The second comparator unit (V₂) ascertains a plurality of preciseness values of the second layer output (a₂) that are smaller than a second threshold value (T₂). The ascertained preciseness values are then set to zero, and the second layer output (a₂), modified in this way, is provided, as second intermediate output (z₂), to a third layer (not shown). In alternative exemplary embodiments (not shown), it is possible that the second comparator unit (V₂) also ascertain, for each preciseness value, whether the preciseness value is below a threshold value defined specifically for the preciseness value.

Except for the final layer (Lₙ), further intermediate outputs of further layers are ascertained analogously to the procedure in the case of the second layer. A corresponding layer thus receives a correspondingly previously ascertained intermediate output, and, for it, produces a layer output which is then compared with a threshold value by a comparator unit. The preciseness values of the layer output that are smaller than the threshold value are set to zero, and the layer output, modified in this way, is provided to a subsequent layer as intermediate output.

The final layer (Lₙ) receives a final intermediate output (zₙ) of a layer preceding the final layer. Based on the final intermediate output (zₙ), the final layer (Lₙ) then ascertains an expected value (yₘ) and a preciseness value (yₑ), which together characterize a fusion of the plurality (x) of sensor signals. For the ascertaining of the expected value (yₘ) and of the preciseness value (yₑ), the final layer (Lₙ) uses a stochastic neuron.

In further exemplary embodiments (not shown), it is possible that the sensor signals represent vectorial physical variables, for example the expected value and preciseness value of a position in a three-dimensional space. In these exemplary embodiments, the final layer (Lₙ) has as many stochastic neurons as the physical variable has dimensions. Each stochastic neuron can then determine a dimension of the expected value and of the preciseness value.

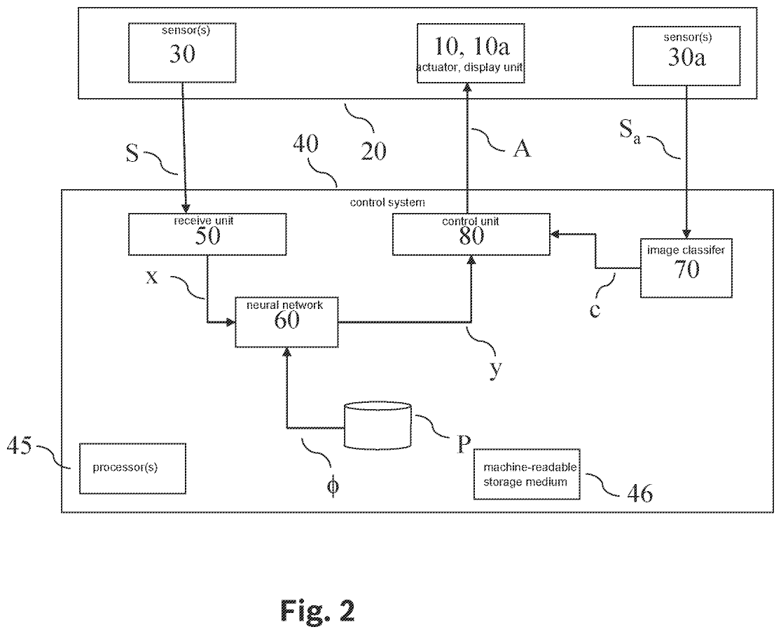

FIG. 2 shows an actuator (10) in its environment (20), in interaction with a control system (40). At preferably regular temporal intervals, the environment (20) is acquired by a plurality of first sensors (30). The sensor signals (S) of the plurality of first sensors (30) are communicated to the control system (40). The control system (40) thus receives a sequence of sensor signals (S). From this, the control system (40) ascertains control signals (A) that are transmitted to the actuator (10). For this purpose, the sensor signals (S) include an expected value and a preciseness value.

The control system (40) receives the sequence of sensor signals (S) of the first sensors (30) in an optional receive unit (50) that converts the sequence of sensor signals (S) into a sequence of input signals (x) (alternatively, the sensor signals (S) of the first sensors (30) can also be taken over directly). The input signals (x) can for example be a segment or a further processing of the sensor signals (S). In other words, the input signals (x) are ascertained as a function of the sensor signals (S). The sequence of input signals (x) is supplied to the neural network (60).

The neural network (60) is preferably parameterized by parameters (ϕ) that are stored in a parameter memory (P) and are provided by it. In particular, the parameters (ϕ) include the weights of the neural network.

The neural network (60) ascertains from the input signals (x) a fused output signal (y) that includes the expected value (yₘ) and the preciseness value (yₑ). The output signal (y) is supplied to a control unit (80) that ascertains therefrom control signals (A) that are supplied to the actuator (10) in order to correspondingly control the actuator (10). In further exemplary embodiments, the control unit (80) can receive further signals from other components of the control system in order to control the actuator (10). In particular, the control unit (80) can receive a classification signal (c) of an image classifier (70), the classification signal (c) preferably characterizing a classification of the environment (20) by the image classifier (70) on the basis of at least one camera signal (Sₐ) of at least one second sensor (30a), for example a camera or video sensor, a lidar sensor, or a radar sensor. For example, the classification signal (c) can characterize a classification of objects in the surrounding environment (20) of the control system (40).

The actuator (10) receives the control signals (A), is correspondingly controlled, and carries out a corresponding action. Here, the actuator (10) can include a control logic system (not necessarily integrated in the construction), which ascertains, from the control signal (A), a second control signal with which the actuator (10) is then controlled.

In further specific embodiments of the present invention, the control system (40) includes the sensor (30). In still further specific embodiments, the control system (40) also includes, alternatively or in addition, the actuator (10).

In further preferred specific embodiments of the present invention, the control system (40) includes at least one processor (45) and at least one machine-readable storage medium (46) on which instructions are stored that, when they are executed on the processors (45), cause the control system (40) to carry out the method according to the present invention.

In alternative specific embodiments of the present invention, alternatively or in addition to the actuator (10) a display unit (10a) is provided that is controlled by the control signal (A). Here, alternatively or in addition, with the control signal (A) the display unit (10a) can be controlled, and for example the result of the fusion of the sensor signals (30) can be displayed.

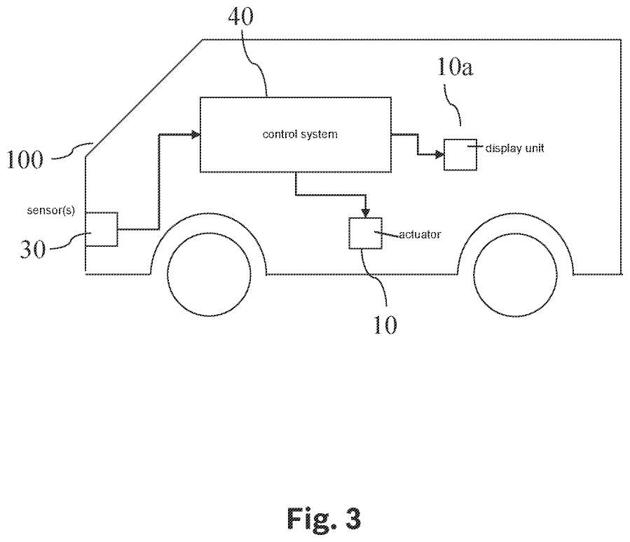

FIG. 3 shows how the control system (40) can be used for the controlling of an at least partly autonomous robot, here an at least partly autonomous motor vehicle (100).

The first sensors (30) can for example be ultrasonic sensors, preferably situated in the motor vehicle (100), by which a wetness value is measured of a street on which the motor vehicle (100) is moving. Here, the ultrasonic sensors (30) each ascertain an expected value of the wetness value as well as a preciseness value of the wetness value.

The neural network (60) is configured to fuse the sensor signals (S) of the various ultrasonic sensors (30), and to ascertain an expected value (yₘ) relating to the wetness value and a preciseness value (yₑ) relating to the wetness value. The expected value (yₘ) and the preciseness value (yₑ) are outputted in the output signal (y) by the neural network (60). For this purpose, in this exemplary embodiment the neural network (60) includes in the final layer (Lₙ) a stochastic neuron that ascertains the expected value (yₘ) and the preciseness value (yₑ).

The image classifier (70) is configured to detect, from video recordings (Sₐ) of the surrounding environment (20) using camera sensors (30a), objects with which the motor vehicle (100) is not permitted to collide, in particular other roadway participants, such as other motor vehicles, pedestrians, or bicyclists. The objects classified by the image classifier (70) are communicated to the control unit (80) by the classification signal (c).

The actuator (10), preferably situated in the motor vehicle (100), can for example be a brake, a drive mechanism, or a steering system of the motor vehicle (100). The control signal (A) can then be ascertained in such a way that the actuator or actuators (10) are controlled in such a way that the motor vehicle (100) for example prevents a collision with the objects identified by the image classifier (70), in particular when these are objects of particular classes, e.g., pedestrians. The control signal (10) of the actuator (10) is, however, also determined by the expected value (yₘ) of the wetness value and by the preciseness value (yₑ) of the wetness value, which are ascertained by the neural network (60). If, for example, the preciseness value (yₑ) exceeds a predefined third threshold value or is equal to it, it can be assumed that the expected value (yₘ) precisely characterizes the actual wetness of the street. In this case, the motor vehicle (100) can continue its travel without limitations, if the expected value (yₘ) is below a predefined fourth threshold value. If the expected value (yₘ) is greater than or equal to the fourth threshold value, then for example a maximum speed with which the motor vehicle (100) is permitted to travel can be reduced. This limitation can also be chosen if the preciseness value (yₑ) is below the third threshold value.

It is also possible, for example in the case of a motor vehicle (100) not having automated steering, for the display unit (10a) to be controlled with the control signal (A) in such a way that it outputs an optical or acoustic warning signal when the preciseness value (yₑ) falls below the third threshold value, or when the expected value (yₘ) exceeds the fourth threshold value or is equal to it.

Alternatively, the first sensors (30) can also be sensors for determining position, for example GPS sensors, GLONASS sensors, Galileo sensors, or Beidou sensors. In this case, the neural network (60) can in each case ascertain four expected values relating to the position and four preciseness values relating to the position, and output them in the output signal (y). In this exemplary embodiment, the neural network (60) uses four stochastic neurons in the final layer (Lₙ), each of which ascertains an expected value and a preciseness value. The number of expected values and preciseness values is chosen only as an example in this exemplary embodiment. The number of desired expected values and preciseness values can be defined via the number of stochastic neurons in the final layer (Lₙ) of the neural network (60).

The actuator (10) can then for example be controlled in such a way that particular automated driving functions can be deactivated as a function of the position of the motor vehicle (100). For example, it is possible that the motor vehicle (100) be permitted to drive in automated fashion only if it is in a particular country, and for this function to be switched off as soon a border with another country is crossed.

Alternatively, the at least partly autonomous robot can also be another mobile robot (not shown), for example one that moves by flying, swimming, immersion, or stepping. The mobile robot can for example also be an at least partly autonomous lawnmower, or an at least partly autonomous cleaning robot. In these cases as well, the control signal (A) can be ascertained in such a way that the drive mechanism and/or steering system of the mobile robot are controlled in such a way that the at least one partly autonomous robot for example prevents a collision with objects identified by the image classifier (70).

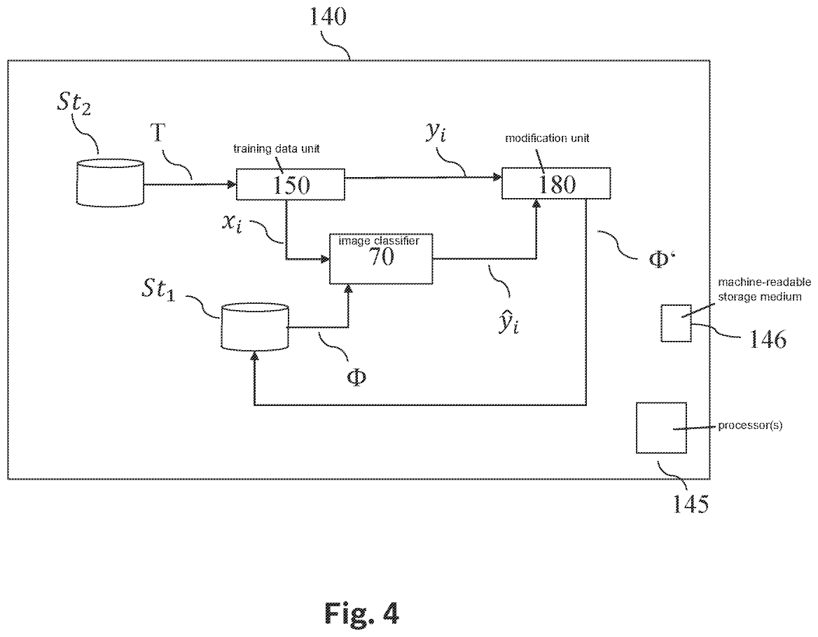

FIG. 4 shows an exemplary embodiment of a training system (140) that is designed to train the neural network (60). For the training, a training data unit (150) accesses a computer-implemented database (St₂), the database (St₂) including at least one training data set (T), the training data set (T) including respective tuples of sensor recordings (xᵢ) and of a desired output signal (yᵢ), where the sensor recordings (xᵢ) are recordings of a plurality of sensor signals that are to be fused by the neural network (60), and the desired output signal (yᵢ) is to be ascertained by the neural network.

The training data unit (150) ascertains at least one tuple of sensor recordings (xᵢ) and desired output signals (yᵢ) of the training data set (T), and communicates the sensor recordings (xᵢ) to the neural network (60). The neural network (60) ascertains an output signal (ŷᵢ) on the basis of the sensor recordings (xᵢ).

The desired output signal (yᵢ) and the ascertained output signal (ŷᵢ) are communicated to a modification unit (180).

Based on the ascertained output signal (9) and the desired output signal (yᵢ), the modification unit (180) then determines new modeling parameters (ϕ′), in particular new weights, for the neural network. For this purpose, the modification unit (180) compares the ascertained output signal (ŷᵢ) with the desired output signal (yᵢ) using a loss function. The loss function ascertains a measure of how far the ascertained output signal (ŷᵢ) deviates from the desired output signal (yᵢ). As loss function, preferably L1 loss or L2 loss can be selected. Preferably, the result of a further loss function, ascertained on the basis of the modeling parameters (ϕ), is added to the L1 loss or to the L2 loss. The further loss function can for example be a Frobenius norm of the weights of the neural network (60).

On the basis of the ascertained measure of the, the modification unit (180) ascertains the new model parameters (ϕ′). In the exemplary embodiment, this is done using a gradient descent method, preferably stochastic gradient descent or Adam.

The ascertained new model parameters (ϕ′) are stored in a model parameter memory (St₁).

In further exemplary embodiments, the described training is repeated iteratively for a predefined number of iteration steps, or is iteratively repeated until the measure falls below a predefined threshold value. In at least one of the iterations, the new model parameters (ϕ′) determined in a previous iteration are used as model parameters (ϕ) of the neural network.

In addition, the training system (140) can include at least one processor (145) and at least one machine-readable storage medium (146) that contains commands that, when they are executed by the processor (145), cause the training system (140) to carry out a training method according to one of the aspects of the present invention.

The term “computer” includes any devices for processing specifiable computing rules. These computing rules may be in the form of software, or in the form of hardware, or also in a mixed form of software and hardware.

What is claimed is:

1. A computer-implemented method for fusing a plurality of sensor signals using a neural network, wherein each sensor signal includes at least one first value that characterizes an expected value of a physical variable, and includes a second value that characterizes a scatter of the physical variable, the method comprising the following steps:
ascertaining, using the neural network, based on the plurality of sensor signals, an output that characterizes a fusion of the plurality of the sensor signals, the output being a function of a first intermediate output of the neural network, the first intermediate output being ascertained by at least one first neuron and includes an ascertained first value that characterizes an expected value of the fusion of the plurality of sensor values, and includes an ascertained second value that characterizes a scatter of the fusion, the ascertained second value of the first intermediate output being set to zero when a specifiable condition is fulfilled.

2. The method as recited in claim 1, wherein the ascertained second value of the first intermediate output is set to zero when the ascertained second value falls below a predefined threshold value.

3. The method as recited in claim 1, wherein the intermediate output is ascertained by a plurality of neurons and includes a plurality of ascertained first values and a plurality of ascertained second values, each of the ascertained second values being set to zero when the ascertained second value belongs to a predefined number of smallest values of the ascertained second values.

4. The method as recited in claim 1, wherein the ascertaining of the first intermediate output is carried out by a computing unit for operations on sparsely occupied matrices, or sparse matrix operations, the computing unit being configured to carry out the operations using a hardware acceleration.

5. A computer-implemented method for training a neural network, wherein the neural network is configured to ascertain, based on a plurality of sensor signals, an output that characterizes a fusion of the plurality of the sensor signals, each sensor signal including at least one first value that characterizes an expected value of a physical variable, and includes a second value that characterizes a scatter of the physical variable, the output being a function of a first intermediate output of the neural network, the first intermediate output being ascertained by at least one first neuron and includes an ascertained first value that characterizes an expected value of the fusion of the plurality of sensor values, and includes an ascertained second value that characterizes a scatter of the fusion, the ascertained second value of the first intermediate output being set to zero when a specifiable condition is fulfilled, the method comprising:
training the neural network based on a loss function.

6. The method as recited in claim 5, wherein the loss function includes a norm of at least a portion of a plurality of weights of a stochastic neuron.

7. A computer having a computing unit, the computer being configured to fuse a plurality of sensor signals using a neural network, wherein each sensor signal includes at least one first value that characterizes an expected value of a physical variable, and includes a second value that characterizes a scatter of the physical variable, the computer configured to:
ascertain, using the neural network, based on the plurality of sensor signals, an output that characterizes a fusion of the plurality of the sensor signals, the output being a function of a first intermediate output of the neural network, the first intermediate output being ascertained by at least one first neuron and includes an ascertained first value that characterizes an expected value of the fusion of the plurality of sensor values, and includes an ascertained second value that characterizes a scatter of the fusion, the ascertained second value of the first intermediate output being set to zero when a specifiable condition is fulfilled;
wherein the ascertainment of the first intermediate output is carried out by the computing unit, the computing unit being for operations on sparsely occupied matrices, or sparse matrix operations, the computing unit being configured to carry out the operations using a hardware acceleration.

8. A training device configured to train a neural network, wherein the neural network is configured to ascertain, based on a plurality of sensor signals, an output that characterizes a fusion of the plurality of the sensor signals, each sensor signal including at least one first value that characterizes an expected value of a physical variable, and includes a second value that characterizes a scatter of the physical variable, the output being a function of a first intermediate output of the neural network, the first intermediate output being ascertained by at least one first neuron and includes an ascertained first value that characterizes an expected value of the fusion of the plurality of sensor values, and includes an ascertained second value that characterizes a scatter of the fusion, the ascertained second value of the first intermediate output being set to zero when a specifiable condition is fulfilled, the training device being configured to train the neural network based on a loss function.

9. A non-transitory machine-readable storage medium on which is stored a computer program for fusing a plurality of sensor signals using a neural network, wherein each sensor signal includes at least one first value that characterizes an expected value of a physical variable, and includes a second value that characterizes a scatter of the physical variable, the computer program, when executed by a computer, causing the computer to perform the following steps:
ascertaining, using the neural network, based on the plurality of sensor signals, an output that characterizes a fusion of the plurality of the sensor signals, the output being a function of a first intermediate output of the neural network, the first intermediate output being ascertained by at least one first neuron and includes an ascertained first value that characterizes an expected value of the fusion of the plurality of sensor values, and includes an ascertained second value that characterizes a scatter of the fusion, the ascertained second value of the first intermediate output being set to zero when a specifiable condition is fulfilled.
